(19) United States
(12) Patent Application Publication
(10) Pub. No.: US 2013/0060574 A1
(43) Pub. Date: Mar. 7, 2013

(54) PROVISION OF A MOBILE HEALTH PRODUCT

(71) Applicants: Lee H. Perlman, Larchmont, NY (US); Paul Shelton Nerger, San Francisco, CA (US); Corey B. Ackerman, Morganville, NJ (US)

(72) Inventors: Lee H. Perlman, Larchmont, NY (US); Paul Shelton Nerger, San Francisco, CA (US); Corey B. Ackerman, Morganville, NJ (US)

(21) Appl. No.: 13/227,026

(22) Filed: Sep. 7, 2011

(51) Int. Cl. G06Q 50/22

(52) U.S. Cl. 705/2

(57) ABSTRACT

Described are methods, systems, and apparatus, including computer program products for providing a mobile health product. A method of providing a mobile health product includes receiving via a communications network, by a server, a request from a physician to provide the mobile health product to a patient, the request comprising a patient identifier that identifies the patient and a physician identifier that identifies the physician. Patient information based on the patient identifier, physician information based on the physician identifier, and insurance information based on the patient information and the mobile health product is retrieved by the server. In the event that the physician information indicates that the physician is authorized to prescribe the mobile health product, and the patient information and the insurance information permit payment for the mobile health product, the method includes causing the mobile health product to be delivered to the patient.

### FIELD OF THE TECHNOLOGY

The present technology relates generally to provision of a mobile health product and, more specifically, to fulfillment of a prescription for a mobile health product.

### BACKGROUND

Mobile health is an area of growth driven in part by the increasing use of mobile health products, such as mobile computing platforms, mobile health applications that run on mobile computing platforms, and peripherals. Physicians and other healthcare providers utilize mobile computing platforms loaded with mobile health applications to improve patient care, along with other aspects of their jobs. For example, mobile health applications can be used to help health care providers more accurately estimate and calculate healthcare parameters, illustrate and explain health conditions to patients, access and edit electronic health records, and utilize peripherals, such as probes, meters, or other mobile health hardware, for diagnostic purposes.

Patients can also use mobile health products. Patients can use mobile health products to help manage particular medical conditions or their overall wellbeing. Some mobile health products are advisory in nature, such as dealing with first aid or weight management. Other mobile health products provide guidance, such as reminding a patient when she should take her medication. Still other mobile health products allow patients to use peripherals, such as probes or meters, connected to a mobile computing platform to monitor glucose levels and heart rates. Some mobile health products also communicate data to physicians in realtime.

As health care providers and patients increasingly use mobile health products, health care providers can, for example, recommend and, in some cases, prescribe mobile health products to patients to help the patients manage or alleviate their conditions.

### SUMMARY

With the increased use of mobile health products, physicians and patients can benefit from a mobile health product prescription fulfillment mechanism. The technology described herein provides efficient mobile health product prescription fulfillment, while simplifying, for physicians and patients, prescribing and receiving mobile health products.

In one aspect, the technology features a method of providing a mobile health product. The method involves receiving via a communications network, by a server, a request from a physician to provide the mobile health product to a patient, the request comprising a patient identifier that identifies the patient and a physician identifier that identifies the physician. The method involves retrieving, by the server, patient information based on the patient identifier and physician information based on the physician identifier. The method involves causing the mobile health product to be delivered to the patient, in the event that the physician information indicates that the physician is authorized to prescribe the mobile health product, and the patient information permits payment for the mobile health product.

In another aspect, the technology features a method of providing a mobile health product, including receiving via a communications network, by a server, a request from a physician to provide the mobile health product to a patient, the request comprising a patient identifier that identifies the patient and a physician identifier that identifies the physician. The method involves retrieving, by the server, patient information based on the patient identifier, physician information based on the physician identifier, and insurance information based on the patient information and the mobile health product. The method involves causing the mobile health product to be delivered to the patient, in the event that the physician information indicates that the physician is authorized to prescribe the mobile health product, and the patient information and the insurance information permit payment for the mobile health product.

Any of the above aspects can include one or more of the following features. In some embodiments, the method includes receiving authorization from the patient to provide the mobile health product. In some embodiments the mobile health product can be mobile health software, mobile health hardware, or any combination thereof.

In some embodiments, the mobile health product includes mobile health software and causing the mobile health product to be delivered to the patient includes sending, to the patient, an electronic notification identifying a location from where the patient can download the mobile health software.

In some embodiments, the patient information permits payment for the mobile health product provided that the patient information indicates a method for paying a cost of the mobile health product. In some embodiments, the patient information and the insurance information permit payment for the mobile health product provided that the insurance information indicates an insurance company will pay for a portion or all of a cost of the mobile health product, and the patient information indicates a method for paying a remaining portion of the cost that the insurance company will not pay, if any.

In some embodiments, the method involves requesting the physician information from a licensing server.

In some embodiments, the method involves determining whether the mobile health product is compatible with a mobile device used by the patient.

In some embodiments, the method involves prompting the patient for the patient information, if the patient information is not stored on the server; and storing the patient information on the server.

In another aspect, the technology features a computer program product, tangibly embodied in a non-transitory computer-readable storage medium, for providing a mobile health product, the computer program product including instructions being operable to cause a data processing apparatus to receive via a communications network, by a server, a request from a physician to provide the mobile health product to a patient, the request comprising a patient identifier that identifies the patient and a physician identifier that identifies the physician. The computer program product includes instructions being operable to cause a data processing apparatus to retrieve, by the server, patient information based on the patient identifier, physician information based on the physician identifier, and insurance information based on the patient information and the mobile health product. The computer program product includes instructions being operable to cause a data processing apparatus to cause the mobile health product to be delivered to the patient, in the event that the physician information indicates that the physician is authorized to prescribe the mobile health product, and the patient information and the insurance information permit payment for the mobile health product.

In some embodiments, the computer program product includes instructions being operable to cause a data processing apparatus to receive authorization from the patient to provide the mobile health product.

In some embodiments, the mobile health product can be mobile health software, mobile health hardware, or any combination thereof

In some embodiments, the mobile health product can be mobile health software and the instructions being operable to cause a data processing apparatus to cause the mobile health product to be delivered to the patient include instruction to send, to the patient, an electronic notification identifying a location from where the patient can download the mobile health software.

In some embodiments, the patient information and the insurance information permit payment for the mobile health product provided that the insurance information indicates an insurance company will pay for a portion or all of a cost of the mobile health product, and the patient information indicates a method for paying a remaining portion of the cost that the insurance company will not pay, if any.

In some embodiments, the computer program product includes instructions being operable to cause a data processing apparatus to request the physician information from a licensing server.

In some embodiments, the computer program product includes instructions being operable to cause a data processing apparatus to determine whether the mobile health product is compatible with a mobile device used by the patient.

In some embodiments, the computer program product includes instructions being operable to cause a data processing apparatus to prompt the patient for the patient information, if the patient information is not stored on the server; and store the patient information on the server.

In another aspect, the technology features a method of providing a mobile health product that involves receiving via a communications network, by an order processing server, a request from a mobile computing device running a mobile application store client to provide the mobile health product to a patient, the request comprising a patient identifier that identifies the patient and a physician identifier that identifies a physician that initiated the request. The method involves retrieving, by the order processing server, previously-stored patient information based on the patient identifier, the patient information comprising patient payment information and patient delivery information. The method involves retrieving via the communications network from a licensing server, by the order processing server, physician information based on the physician identifier. The method involves retrieving via the communications network from an insurance server, by the order processing server, insurance information based on the patient information and the mobile health product, the insurance information indicating whether a cost of the mobile health product will be paid by the patient's insurance. The method involves causing, by the order processing server, the mobile health product to be delivered to the patient via a delivery method based on the patient delivery information, in the event that the physician information indicates that the physician is authorized by a licensing body to prescribe the mobile health product, and the patient payment information and the insurance information permit payment of the cost of the mobile health product.

In some embodiments, the method involves receiving authorization from the patient to provide the mobile health product. In some embodiments, the mobile health product can be mobile health software, mobile health hardware, or any combination thereof.

In some embodiments, the mobile health product includes mobile health software and wherein causing the mobile health product to be delivered to the patient includes sending, to the patient, an electronic notification identifying a location from where the patient can download the mobile health software.

Other aspects and advantages of the technology will become apparent from the following detailed description, taken in conjunction with the accompanying drawings, illustrating the aspects of the technology by way of example only.

### BRIEF DESCRIPTION OF THE DRAWINGS

The foregoing and other objects, features, and advantages of the technology, as well as the technology itself, will be more fully understood from the following description of various embodiments, when read together with the accompanying drawings, in which:

FIG. 1 depicts a mobile health product store application screen, according to an illustrative embodiment of the technology;

FIG. 2 depicts a mobile health product store application screen, according to an illustrative embodiment of the technology;

FIG. 3 depicts an email sent to the recipient of a mobile health prescription, according to an illustrative embodiment of the technology;

FIG. 4 depicts an email sent to the recipient of the mobile health prescription, according to an illustrative embodiment of the technology;

FIG. 5 is a diagram of an exemplary network environment, according to an illustrative embodiment of the technology;

FIG. 6 is a data flow chart illustrating the data flow for a method of providing a mobile health product, according to an illustrative embodiment of the technology;

FIG. 7 is a flowchart depicting a method of providing a mobile health product, according to an illustrative embodiment of the technology;

FIG. 8 is a flowchart depicting a method of providing a mobile health product, according to an illustrative embodiment of the technology.

### DETAILED DESCRIPTION

A physician-patient consultation provides an illustrative example of a context in which the technology can be used to facilitate prescribing a mobile health product. During a physician-patient consultation, a physician can determine that the patient would benefit from using a mobile health product. In some instances, the physician might be aware of an appropriate mobile health product for the patient. In some instances, the physician can search for an appropriate mobile health product for the patient based on the features or functions that the physician believes will benefit the patient. In these and other instances, the physician can use an online mobile health product store to facilitate locating an appropriate mobile health product. An online mobile health product store can provide a centralized source of information about a variety of mobile health products and facilitate locating an appropriate mobile health product for the patient. An example of an online mobile health store is the Happtique mobile application store operated by Happtique, Inc. of New York.

Once the physician has chosen the mobile health product to prescribe to the patient, other issues, such as whether the physician is authorized by the appropriate licensing authority to prescribe the mobile health product, how the mobile health product will be paid for, and how the mobile health product will be provided to the patient, affect whether the prescribed mobile health product can be provided to the patient. The described technology can facilitate a physician with prescribing a mobile health product and the patient with paying for and receiving the mobile health product by efficiently addressing these and other issues.

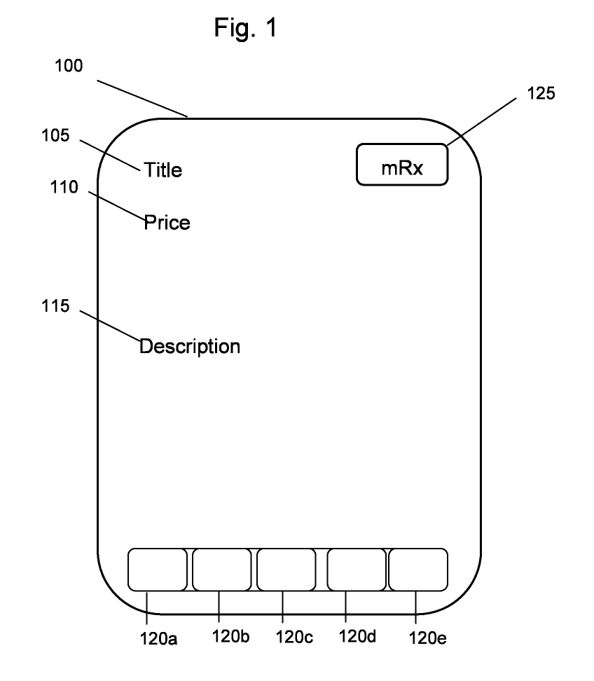

FIG. 1 depicts a mobile health product store application screen 100, according to an illustrative embodiment of the technology. The mobile health product store application screen 100 can be accessed with a personal computer, a smartphone, or any mobile computing device (not shown). Screen 100 can display information about a mobile health product. For example, screen 100 can include various text, such as a title 105, a price 110, and a description 115, relating to the mobile health product. Screen 100 can include buttons 120a-120e, which can provide navigation, search, or other functionality within the mobile health product store application. Screen 100 can include mRx button 125.

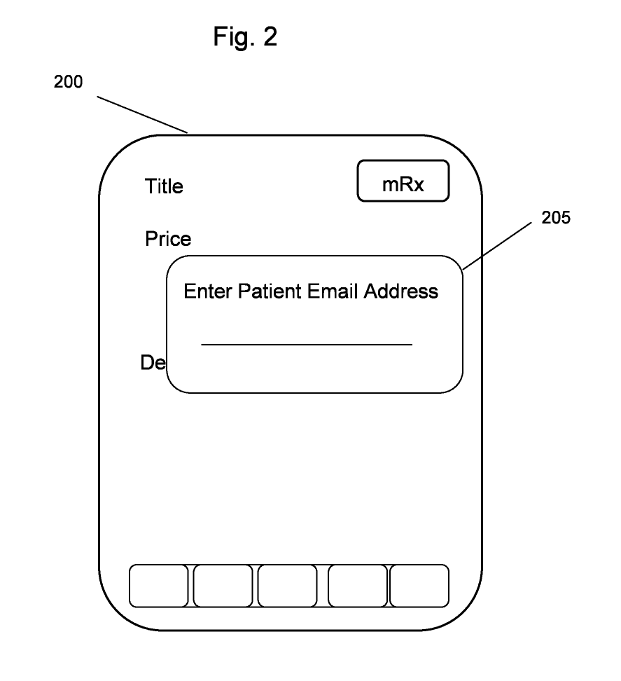

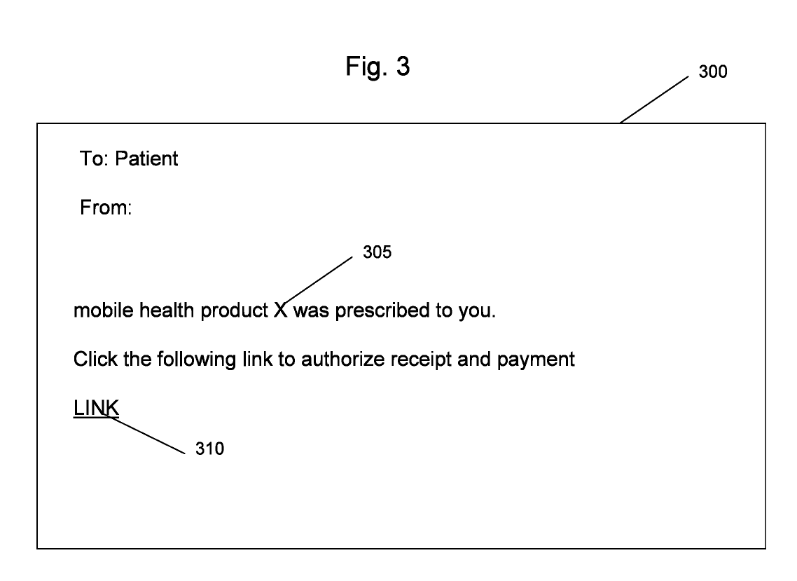

The physician can prescribe the mobile health product to the patient from screen 100. To prescribe the mobile health product to the patient, the physician can press mRx button 125, which causes screen 200 of FIG. 2 to be displayed. FIG. 2 depicts a mobile health product store application screen 200, according to an illustrative embodiment of the technology. Mobile health product store application screen 200 includes dialog box 205 which prompts the physician to enter the patient's email address. After the physician enters the patient's email address into dialog box 205, an email is sent to the patient's email address. FIG. 3 depicts an email 300 sent to the recipient of a mobile health prescription, according to an illustrative embodiment of the technology. Email 300 identifies the mobile health product 305 that was prescribed and provides a link 310 for the patient to click to authorize payment for and receipt of the mobile health product 305.

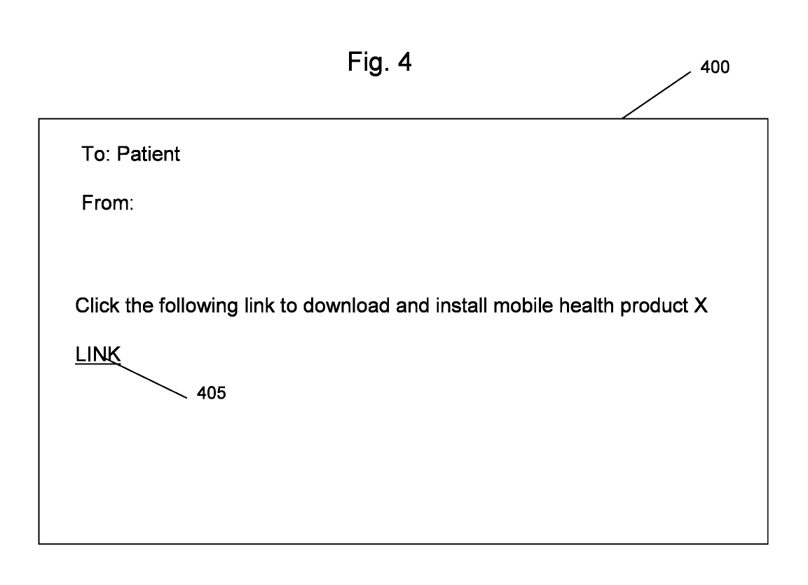

After the patient authorizes payment for and receipt of the mobile health product, the technology, as described in detail below, can fulfill the prescription. FIG. 4 depicts an email 400 sent to the recipient of the mobile health prescription, according to an illustrative embodiment of the technology. Email 400 includes a link 405 from which to download and install the mobile health product. In the illustrated example, the mobile health product can be software that can be provided electronically (e.g., via download from a server). In some instances, a mobile health product can include physical devices, such as mobile computing devices or peripherals. In such cases, the physical devices can be delivered via a package delivery service.

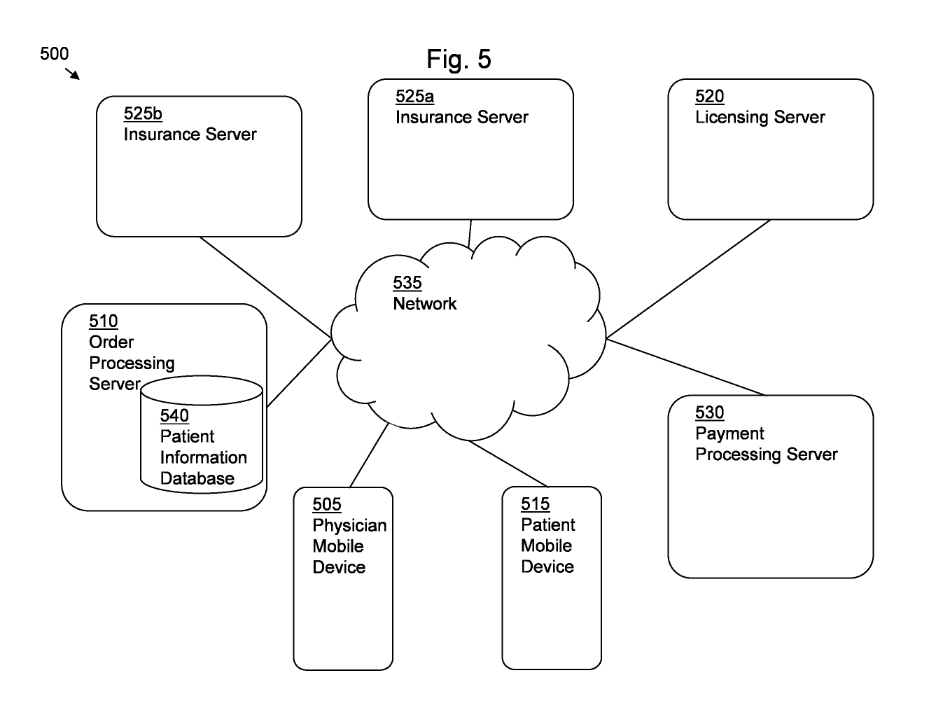

FIG. 5 is a diagram of an exemplary network environment 500, according to an illustrative embodiment of the technology. Network environment 500 can include a physician mobile device 505, an order processing server 510, a patient mobile device 515, a licensing server 520, insurance servers 525a and 525b (generally insurance server 525), and a payment processing server 530, each of which can be connected to network 535.

Physician mobile device 505 can be a mobile computing device. A mobile computing device as used herein refers to any mobile device with a processor and memory that can execute instructions. Mobile computing devices include, but are not limited to, portable computers, personal digital assistants, cellular telephones, tablet computers, and other portable, network-connected devices. Physician mobile device 505 can include a wired or wireless interface connected to network 535. In some instances, physician mobile device 505 includes a web browser that facilitates interfacing with an online mobile health product store. In some instances, physician mobile device 505 includes an application that facilitates interfacing with order processing server 510. More generally, physician mobile device 505 can be any mobile computing device capable of interfacing with order processing server 510.

In some configurations, physician mobile device 505 can connect to an online mobile health store (described above) to facilitate searching for and prescribing a mobile health product. For example, physician mobile device 505 can be configured to display screen 100 of FIG. 1 and screen 200 of FIG. 2.

Order processing server 510 can be a computing device. A computing device as used herein refers to any device with a processor and memory that can execute instructions. Computing devices include, but are not limited to, personal computers, servers, portable computers, personal digital assistants, cellular telephones, tablet computers, and other network-connected devices. In some embodiments, order processing server 510 can host an online mobile health store. Order processing server 510 can include patient information database 540. Patient information database 540 can be any software or hardware storage device configured to store information. While patient information database 540 is depicted as a part of order processing server 510 in the illustrated embodiment, in some embodiments patient information database 540 can be a separate computing device.

Patient mobile device 515 can be a mobile computing device. Patient mobile device 515 can include a wired or wireless interface connected to network 535. In some instances, patient mobile device 515 includes an email client and a web browser that facilitates interfacing with order processing server 510.

Licensing server 520 can be a computing device. In some embodiments, licensing server 520 can be operated by the appropriate medical licensing authority for the state in which the physician practices (e.g., the Board of Registration). Licensing server 520 can provide an interface to which other computing devices establish a connection and request the licensing status of physicians. Communications with licensing server 520 can occur using any appropriate protocol. In some embodiments, the interface can be a website utilizing the Hypertext Transfer Protocol (“HTTP”). In some embodiments, the interface can be another communications protocol specified by the authority operating licensing server 520.

Insurance server 525 can be a computing device. In some embodiments, insurance server 525 can be operated by an insurance company (e.g., a patient's insurance company). In some embodiments, insurance servers 525a and 525b can be operated by different insurance companies. Insurance server 525 can provide an interface to which other computing devices establish a connection and request insurance information relating to a patient, such as the patient's insurance status and co-payment amount. Communications with insurance server 525 can occur using any appropriate protocol. In some embodiments, the interface can be a website utilizing HTTP. In some embodiments, the interface can be another communications protocol specified by the insurance company operating insurance server 525.

Payment processing server 530 can a computing device. In some embodiments, payment processing server 530 can be operated by a payment processing company (e.g., a credit card processing company or other intermediary which can confirm payments based on information provided by the patient). Payment processing server 530 can provide an interface to which other computing devices establish a connection and submit for payment. Communications with payment processing server 530 can occur using any appropriate protocol. In some embodiments, the interface can be a website utilizing HTTP. In some embodiments, the interface can be another communications protocol specified by the authority operating payment processing server 530.

The network topology and/or arrangement of devices shown in FIG. 5 is merely for purposes of illustration. Other network topologies can be used with the technology. In some embodiments, order processing server 510, licensing server 520, insurance server 525, and payment processing server 530 can be stand-alone computing devices, such as servers running appropriate software. In some embodiments, order processing server 510, licensing server 520, insurance servers 525, and payment processing server 530 can be software modules running on a single computing device. Order processing server 510, licensing server 520, insurance servers 525, and payment processing server 530 can be implemented as any combination of stand-alone computing devices and/or software modules.

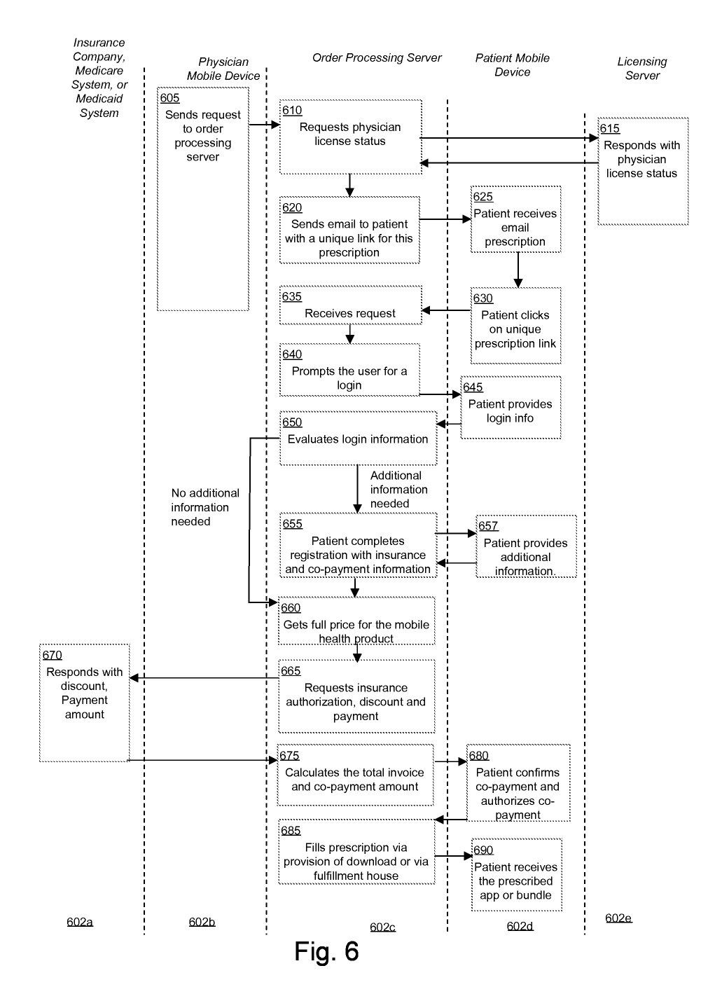

FIG. 6 is a data flow chart 600 illustrating the data flow for a method of providing a mobile health product, according to an illustrative embodiment of the technology. In FIG. 6, each of columns 602a, 602b, 602c, 602d, and 602e logically represents, respectively, insurance server 525, physician mobile device 505, order processing server 510, patient mobile device 515, and licensing server 520 of FIG. 5. Boxes in columns 602a-602e represent actions performed by the device or server that the column represents. Arrows crossing the vertical dashed lines indicate a communication between devices or servers. Communications between devices can occur using any appropriate protocol, such as HTTP, Simple Mail Transfer Protocol (“SMTP”), or Short Message Service (“SMS”). In some embodiments, storage of data and communications between systems comply with the Health Insurance Portability and Accountability Act.

In the illustrated embodiment, a physician can select a mobile health product to prescribe to a patient (e.g., by clicking mRx button 125 of FIG. 1). At 605, the physician mobile device (e.g., physician mobile device 505 of FIG. 5) sends a prescription request for the mobile health product to the order processing server (e.g., order processing server 510 of FIG. 5).

The request can include a patient identifier and a physician identifier. In some embodiments, the patient identifier can be the patient's email address. In some embodiments, the patient identifier can be another alphabetic and/or numeric string that is unique to the particular patient. In some embodiments, the physician identifier can be the physician's license number, as provided by the state in which the physician is licensed. In some embodiments, the physician identifier can be the physician's email address or another alphabetic and/or numeric string that is unique to the particular physician.

At 610, the order processing server requests the physician's license status from the licensing server (e.g., licensing server 520 of FIG. 5). The licensing server responds to the order processing server with the physician's license status at 615. If the physician is currently licensed, the order processing server proceeds to 620. If the physician is not currently licensed, the order processing server can notify the physician that he is not authorized to prescribe the mobile health product.

At 620, the order processing server sends an email to the patient mobile device (e.g., patient mobile device 515 of FIG. 5) with a link for the mobile health product prescription. The email can include other information, such as information about the mobile health product and the prescribing physician.

At 625, the patient mobile device receives the email. At 630, the patient views the email on the patient mobile device and clicks on the link. The patient mobile device sends a request to the order processing server for the information identified by the link at 635. For example, the link can point to a web page hosted by the order processing server. When the patient clicks on the link, the patient mobile device can send an HTTP GET request to the order processing server.

At 640, the order processing server requests login information from the patient by sending the request to the patient mobile device. The request can be in the form of a login web page.

At 645, the patient mobile device sends the patient login information to the order processing server.

At 650, the order processing server retrieves patient information from the patient information database (e.g., patient information database 540 of FIG. 5) based on the patient login information. The patient information can include information about the patient, such as the patient's name, birth date, address, insurance information, credit card number, and type of mobile device.

Also at 650, the prescription processing server determines, based on the patient information retrieved from the patient information database, whether it has enough information to continue processing the mobile health prescription (e.g., does it not have the patient's insurance provider, insurance number, or credit card number). For some prescriptions, the order processing server can also determine whether the prescribed mobile health product is compatible with the patient mobile device. For example, the order processing server can determine if prescribed mobile health software will run on the patient mobile device. Similarly, the order processing server can determine if a peripheral is compatible with the patient mobile device. If the prescribed mobile health product is not compatible with the patient mobile device, the order processing server can send an email to the patient mobile device indicating the incompatibility.

If the order processing server has sufficient information to continue processing the mobile health prescription, the order processing server continues to 660. If additional information is needed, the order processing server requests the additional information from the patient mobile device at 655 (e.g., through a website-based interface). The patient mobile device sends the requested information to the order processing server at 657.

At 660, the order processing server retrieves the full price for the mobile health product. In some embodiments, the order processing server stores a table or database of prices. In some embodiments, the prescription processing serve can retrieve the full price for the mobile health product from, for example, internal records. In some embodiments, the price can be obtained from an online mobile health store.

At 665, the order processing server requests insurance authorization, discount information, and payment from the insurance server (e.g., insurance server 525a or 525b of FIG. 5). The insurance server returns to the order processing server the portion of the full price of the mobile health product covered by the patient's insurance, payment authorization, and co-payment amount.

At 675, the order processing server calculates the total invoice and co-payment amount required from the patient and sends a message to the patient mobile device providing the total invoice amount and co-payment amount required from the patient. The patient mobile device authorizes payment of the invoice amount at 680.

At 685, the order processing server fills the mobile health prescription. If the mobile health product can be delivered electronically, the order processing server can send to the patient mobile device the location from which the mobile health product can be downloaded. Mobile health products that cannot be delivered electronically can be delivered via a package delivery service. At 690, the patient mobile device receives via download the prescribed mobile health product.

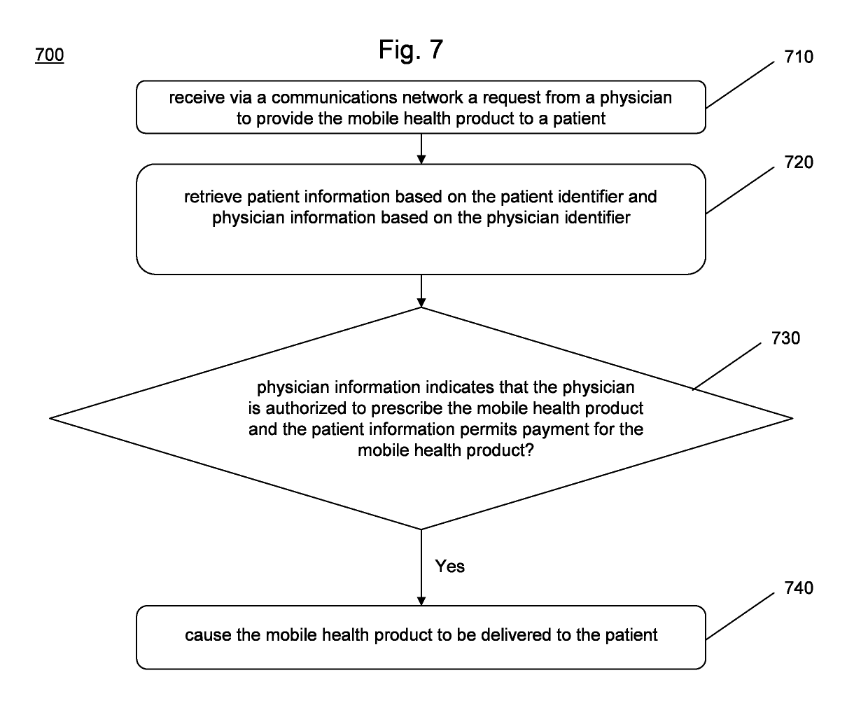

FIG. 7 is a flowchart 700 depicting a method of providing a mobile health product, according to an illustrative embodiment of the technology.

At step 710 a server (e.g. order processing server 510) receives via a communications network (e.g., network 535) a request from a physician to provide the mobile health product to a patient. The request can include a patient identifier that identifies the patient and a physician identifier that identifies the physician.

At step 720, the server retrieves patient information based on the patient identifier. The patient information can include a credit card number which can be used to pay for the cost of the mobile health product.

The server retrieves physician information based on the physician identifier. In some embodiments, the server retrieves the physician information from a licensing server (e.g., licensing server 520). The physician information can include information about whether the physician is currently licensed.

At step 730, the server determines whether the physician information indicates that the physician is authorized to prescribe the mobile health product and the patient information permits payment for the mobile health product. In some embodiments, the physician information indicates that the physician is authorized to prescribe the mobile health product if the physician information indicates the physician is licensed by the appropriate licensing authority. In some embodiments, the patient information permits payment for the mobile health product if the patient information provides a payment method for the total cost of the mobile health product.

At step 740, the server causes the mobile health product to be delivered to the patient if the physician information indicates that the physician is authorized to prescribe the mobile health product, and the patient information and the insurance information permit payment for the mobile health product.

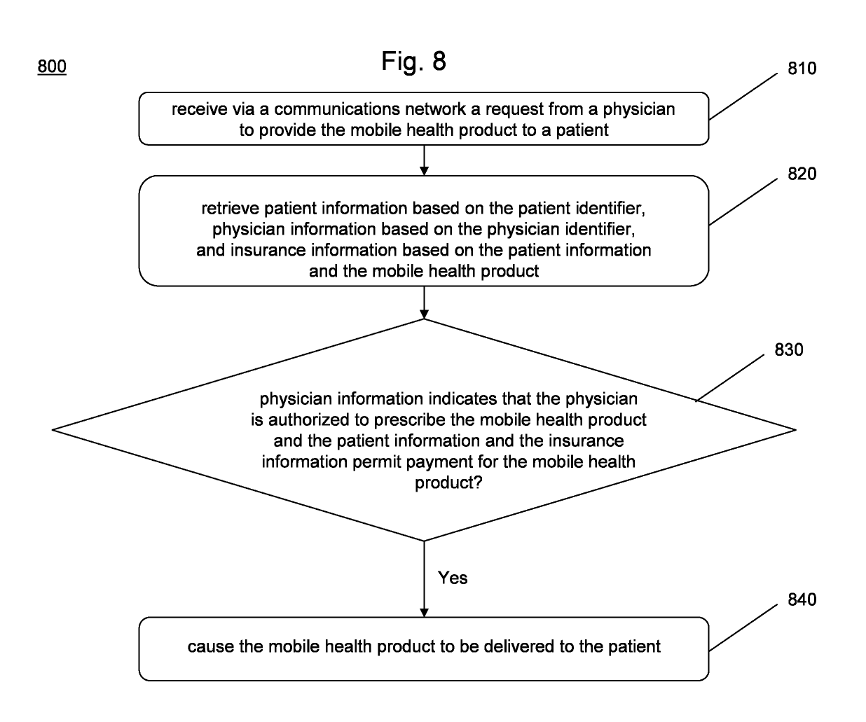

FIG. 8 is a flowchart 800 depicting a method of providing a mobile health product, according to an illustrative embodiment of the technology.

At step 810 a server (e.g. order processing server 510) receives via a communications network (e.g., network 535) a request from a physician to provide the mobile health product to a patient. The request can include a patient identifier that identifies the patient and a physician identifier that identifies the physician.

At step 820, the server retrieves patient information based on the patient identifier. The patient information can include information about the patient's medical insurance, such as the patient's insurance provider and policy number. The patient information can include a credit card number which can be used to pay for co-payment amount or mobile health products not covered by the patient's insurance.

The server retrieves physician information based on the physician identifier. In some embodiments, the server retrieves the physician information from a licensing server (e.g., licensing server 520). The physician information can include information about whether the physician is currently licensed.

The server retrieves insurance information based on the patient information and the mobile health product. In some embodiments, the server retrieves insurance information from an insurance server (e.g., insurance server 525a or 525b). The insurance information can include information about whether the patient's insurance will cover some or all of the cost of the mobile health product.

At step 830, the server determines whether the physician information indicates that the physician is authorized to prescribe the mobile health product, and the patient information and the insurance information permit payment for the mobile health product. In some embodiments, the physician information indicates that the physician is authorized to prescribe the mobile health product if the physician information indicates the physician is licensed by the appropriate licensing authority. In some embodiments, the patient information and the insurance information permit payment for the mobile health product if 1) the insurance information indicates that the patient's insurance covers the full cost of the mobile health product; 2) the insurance information indicates that the patient's insurance covers a portion of the cost of the mobile health product and the patient information provides a payment method for the remainder of the cost of the mobile health product; or 3) the insurance information indicates that the patient's insurance does not cover the cost of the mobile health product and the patient information provides a payment method for the total cost of the mobile health product.

At step 840, the server causes the mobile health product to be delivered to the patient if the physician information indicates that the physician is authorized to prescribe the mobile health product, and the patient information and the insurance information permit payment for the mobile health product.

The above-described technology and techniques can be implemented in digital electronic circuitry, or in computer hardware, firmware, software, or in combinations of them. The implementation can be as a computer program product, i.e., a computer program tangibly embodied in a computer-readable storage medium, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. Generally, a computer also includes, or be operatively coupled to receive data from or transfer data to, or both, one or more mass storage devices for storing data, e.g., magnetic, solid state, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

1. A method of providing a mobile health product comprising:
receiving via a communications network, by a server, a request from a physician to provide the mobile health product to a patient, the request comprising a patient identifier that identifies the patient and a physician identifier that identifies the physician;
retrieving, by the server, patient information based on the patient identifier and physician information based on the physician identifier; and
causing the mobile health product to be delivered to the patient, in the event that the physician information indicates that the physician is authorized to prescribe the mobile health product and the patient information permits payment for the mobile health product.

2. The method of claim 1, further comprising receiving authorization from the patient to provide the mobile health product.

3. The method of claim 1, wherein mobile health product comprises mobile health software, mobile health hardware, or any combination thereof.

4. The method of claim 1, wherein the mobile health product comprises mobile health software and wherein causing the mobile health product to be delivered to the patient comprises sending, to the patient, an electronic notification identifying a location from where the patient can download the mobile health software.

5. The method of claim 1, wherein the patient information permits payment for the mobile health product provided that the patient information indicates a method for paying a cost of the mobile health product.

6. The method of claim 1, further comprising requesting the physician information from a licensing server.

7. The method of claim 1, further comprising determining whether the mobile health product is compatible with a mobile device used by the patient.

8. The method of claim 1, further comprising:
prompting the patient for the patient information, if the patient information is not stored on the server; and
storing the patient information on the server.

9. A method of providing a mobile health product comprising:
receiving via a communications network, by a server, a request from a physician to provide the mobile health product to a patient, the request comprising a patient identifier that identifies the patient and a physician identifier that identifies the physician;
retrieving, by the server, patient information based on the patient identifier, physician information based on the physician identifier, and insurance information based on the patient information and the mobile health product; and
causing the mobile health product to be delivered to the patient, in the event that the physician information indicates that the physician is authorized to prescribe the mobile health product, and the patient information and the insurance information permit payment for the mobile health product.

10. The method of claim 9, further comprising receiving authorization from the patient to provide the mobile health product.

11. The method of claim 9, wherein mobile health product comprises mobile health software, mobile health hardware, or any combination thereof.

12. The method of claim 9, wherein the mobile health product comprises mobile health software and wherein causing the mobile health product to be delivered to the patient comprises sending, to the patient, an electronic notification identifying a location from where the patient can download the mobile health software.

13. The method of claim 9, wherein the patient information and the insurance information permit payment for the mobile health product provided that the insurance information indicates an insurance company will pay for a portion or all of a cost of the mobile health product, and the patient information indicates a method for paying a remaining portion of the cost that the insurance company will not pay, if any.

14. The method of claim 9, further comprising requesting the physician information from a licensing server.

15. The method of claim 9, further comprising determining whether the mobile health product is compatible with a mobile device used by the patient.

16. The method of claim 9, further comprising:
prompting the patient for the patient information, if the patient information is not stored on the server; and
storing the patient information on the server.

17. A computer program product, tangibly embodied in a non-transitory computer-readable storage medium, for providing a mobile health product, the computer program product including instructions being operable to cause a data processing apparatus to:
receive via a communications network, by a server, a request from a physician to provide the mobile health product to a patient, the request comprising a patient identifier that identifies the patient and a physician identifier that identifies the physician;
retrieve, by the server, patient information based on the patient identifier, physician information based on the physician identifier, and insurance information based on the patient information and the mobile health product; and
cause the mobile health product to be delivered to the patient, in the event that the physician information indicates that the physician is authorized to prescribe the mobile health product, and the patient information and the insurance information permit payment for the mobile health product.

18. The computer program product of claim 17, further including instructions being operable to cause the data processing apparatus to receive authorization from the patient to provide the mobile health product.

19. The computer program product of claim 17, wherein the mobile health product comprises mobile health software, mobile health hardware, or any combination thereof

20. The computer program product of claim 17, wherein the mobile health product comprises mobile health software and wherein the instructions being operable to cause a data processing apparatus to cause the mobile health product to be delivered to the patient comprises instruction to send, to the patient, an electronic notification identifying a location from where the patient can download the mobile health software.

21. The computer program product of claim 17, wherein the patient information and the insurance information permit payment for the mobile health product provided that the insurance information indicates an insurance company will pay for a portion or all of a cost of the mobile health product, and the patient information indicates a method for paying a remaining portion of the cost that the insurance company will not pay, if any.

22. The computer program product of claim 17, further including instructions being operable to cause the data processing apparatus to request the physician information from a licensing server.

23. The computer program product of claim 17, further including instructions being operable to cause the data processing apparatus to determine whether the mobile health product is compatible with a mobile device used by the patient.

24. The computer program product of claim 17, further including instructions being operable to cause the data processing apparatus to:
prompt the patient for the patient information, if the patient information is not stored on the server; and
store the patient information on the server.

25. A method of providing a mobile health product comprising:
receiving via a communications network, by an order processing server, a request from a mobile computing device running a mobile application store client to provide the mobile health product to a patient, the request comprising a patient identifier that identifies the patient and a physician identifier that identifies a physician that initiated the request;
retrieving, by the order processing server, previously-stored patient information based on the patient identifier, the patient information comprising patient payment information and patient delivery information;
retrieving via the communications network from a licensing server, by the order processing server, physician information based on the physician identifier;
retrieving via the communications network from an insurance server, by the order processing server, insurance information based on the patient information and the mobile health product, the insurance information indicating whether a cost of the mobile health product will be paid by the patient's insurance; and
causing, by the order processing server, the mobile health product to be delivered to the patient via a delivery method based on the patient delivery information, in the event that the physician information indicates that the physician is authorized by a licensing body to prescribe the mobile health product, and the patient payment information and the insurance information permit payment of the cost of the mobile health product.

26. The method of claim 25, further comprising receiving authorization from the patient to provide the mobile health product.

27. The method of claim 25, wherein mobile health product comprises mobile health software, mobile health hardware, or any combination thereof.

28. The method of claim 25, wherein the mobile health product comprises mobile health software and wherein causing the mobile health product to be delivered to the patient comprises sending, to the patient, an electronic notification identifying a location from where the patient can download the mobile health software.
